(19) United States
(12) Patent Application Publication
(10) Pub. No.: US 2004/0110020 A1
(43) Pub. Date: Jun. 10, 2004

(54) Process for coating a substrate

(76) Inventors: Ann Kerstin Birgitta Kjellqvist, Malmo (SE); Leif Tommy Persson, Hjarup (SE)

Correspondence Address: Lainie E. Parker, Akzo Nobel Inc.- Intellectual Property Department, 7 Livingstone Avenue, Dobbs Ferry, NY, 10522, US

(21) Appl. No.: 10/722,317

(22) Filed: Nov. 25, 2003

Related U.S. Application Data
(62) Division of application No. 10/022,716, filed on Dec. 18, 2001.
(60) Provisional application No. 60/266,928, filed on Feb. 7, 2001.

(30) Foreign Application Priority Data
Dec. 19, 2000 (EP) 00204622.5

(51) Int. Cl. B05D 1/36

(52) U.S. Cl. 428/537.1; 427/558; 427/407.1

(57) ABSTRACT

The invention relates to a process for the coating of a wooden, wood-like and/or cellulose-containing substrate comprising the steps of:

a) applying a press coating to the substrate;

b) applying heat and pressure to the coated substrate to cure the press coating and to obtain a substrate with a smooth coating film, with the pressure being such that the substrate is not substantially compressed;

c) applying a top coat on the substrate after the curing of the press coating; and

d) curing said top coat.

As a result of this process, the amount of unreacted double bonds in the coated substrate is at a low level.

This application claims priority of European Patent Application No. 00204622.5 filed on Dec. 19, 2000 and US Provisional Application Serial No. 60/266,928 filed Feb. 7, 2001.

### SUMMARY OF INVENTION

The present invention relates to a process for coating a wooden, wood-like and/or cellulose-containing substrate, for example solid wood, veneer of wood, impregnated paper or reconstituted wood substrates.

### BACKGROUND OF INVENTION

Reconstituted wood substrates are substrates produced from wood particles, fibres, flakes or chips, such as hardboard, medium density fibre board, an oriented strand board also known as a wafer board, flake board, chip board, and particle board. Such a reconstituted wood substrate is typically fabricated under heat and pressure from particles, fibres, flakes or chips. A reconstituted wood substrate is normally produced by treating particles, flakes, chips or fibres with a binder and then arranging these treated particles, flakes, chips or fibres in the form of a mat under dry or wet conditions. The mat is then compressed into a dense substrate, typically in a sheet form, by the application of heat and pressure. In this compression step the mat is compressed to less than 10% of its original thickness, i.e. the thickness of the substrate is compressed by more than 90%. In the wet process, the water is pressed from the mat during this compression step, in the dry process the particles are pressed closely together. The binder binds particles, flakes, chips or fibres and enhances the structural strength and integrity of the reconstituted wood substrate and its water resistance. The reconstituted wood substrate, if desired, may be moulded into a desired shape or provided with a textured surface, such as a wood grain texture. Typical examples of reconstituted wood substrates are hardboard, Medium Density Fibreboard (MDF), High Density Fibreboard (HDF), and chip board.

For example, in JP 57-113051 A a process is disclosed in which a fibre board is prepared. The document describes that wood chips are cooked into a fibrous material and then an adhesive resin is added. The mixture is subsequently hot pressed into a fibre board. Normally, such a mixture is substantially compressed during the hot pressing. After the pressing, the fibre board is released from the hot press. Next, the fibre board is coated with an aqueous solution of an ester compound by means of a spreader, a flow coater or by spraying. A disadvantage of this method is that a relatively large amount of aqueous solution will penetrate into the fibre board.

A problem encountered by coating a wooden, wood-like and/or cellulose-containing substrate is the relatively high absorption of paint into the substrate. This increases the paint consumption of such substrates in comparison to low or non-absorbing substrates. Further, the relatively large amount of paint necessary to coat the substrate results in a longer overall drying time and a larger amount of solvent that has to evaporate from the coating layer.

Additional problems are encountered when radiation curable coating compositions are applied to a wooden, wood-like and/or cellulose-containing substrate. Such a process is described for example in U.S. Pat. No. 4,675,234. This document describes the application of a thin layer of radiation curable coating to a variety of substrates, for instance wood or paper. In order to obtain a thin layer on top of such substrates, a relatively large amount of coating material has to be applied. A disadvantage of this method is that because it is not reached by the radiation, the part of the coating material that penetrates the substrate will not be cured during radiation. The uncured material can give health, safety, and environmental problems.

Nowadays, a primary concern in the coating industry is the need to reduce the emission of solvents, in particular volatile hydrocarbons, into the air. The problems related to incompletely cured radiation curable materials are of importance as well.

### DETAILED DESCRIPTION OF THE INVENTION

The present invention is directed to a process for coating a wooden, wood-like and/or cellulose-containing substrate with a lower paint consumption. In order to achieve this, the process according to the invention comprises the steps of:

a) applying a press coating to the substrate;

b) applying heat and pressure to the coated substrate to cure the press coating and to obtain a substrate with a smooth coating film, with the pressure being such that the substrate is not substantially compressed;

c) applying a top coat to the substrate after the curing of the press coating; and

d) curing said top coat.

For the purpose of the present application, a pressure such that the substrate is not substantially compressed is a pressure where the average thickness of the substrate is reduced by less than 10% of its original value.

A process where the substrate is not substantially compressed includes any process where the substrate is locally compressed by more than 10%, but wherein the average thickness of the substrate is reduced by less than 10% of its original value. Such local compression can occur when a special pattern is applied to the substrate in the step where heat and pressure are applied to the substrate.

In the process according to the present invention, a press coating is used to seal the surface of the substrate and to lower its paint absorption. Normally, the press coating is applied as an aqueous colloidal dispersion also referred to as a polymer latex emulsion. Such a press coating comprises particles of a polymer of an ethylenically unsaturated monomer, the polymer having a T_{g} in the range of 10 to 100° C., and filler and/or pigment particles.

A polymerized latex emulsion suitable for producing a smooth hard coating on the surface or edge of the substrate comprises from 10 to 60 percent by weight of the emulsion solids of polymer particles of a polymer of an ethylenically unsaturated monomer, the polymer having a T_{g} in the range of 10° C. to 100° C., and from 40 to 60 percent by weight of the emulsion solids of pigment and/or filler particles.

The press coating normally not only provides a smooth coating on the surface and/or edges of the substrate, but also a layer that improves the adhesion between the substrate and any further coating layers that are applied to the substrate.

The latex emulsion can be applied to the substrate by conventional means, such as by curtain coater, spray nozzle, roller coater, flow coater or by extrusion, which is particularly useful for coating edges. The layer can be applied on more than one side of the substrate, such as the front and the back or along the edges of a substantially planar substrate or on the surface of a contoured substrate, such as a moulding or a moulded door panel.

Optionally, to accelerate the evaporation of water from the latex emulsion, the substrate is preheated before application of the latex emulsion at a temperature in the range of 30-80° C., preferably 40-60° C., during 10 seconds to 5 minutes.

The latex layer is dried to a hardened layer by reducing its moisture content. Normally, the layer is dried to a moisture content in the range of 0 to 20 percent by weight of the solids content of the layer. The applicable drying temperature and the drying time are suitably adjusted for the polymerized latex emulsion being used and the thickness of the applied layer. The applicable drying temperature typically varies from ambient temperature to 120° C., preferably from 50° C. to 80° C. The drying time is correspondingly reduced for higher applicable drying temperatures and extended for lower applicable drying temperatures. Conventional drying means, such as a convection air drying oven or a conveyer belt passing through a tunnel heated by infrared lights, are suitable.

The dried layer is then pressed for some time at a pressure that varies from 0.1 N/mm² to 3.5 N/mm², preferably from 0.14 N/mm² to 2.0 N/mm². The coated layer can be heated during this pressing action. The temperature and time are adjusted to prevent thermal decomposition of the resultant coating or substrate or sticking of the coating to the press platens. The applicable temperature typically varies from 20° C. to 300° C.

After the pressing step or simultaneously therewith, the latex layer is cured for an applicable cure time and an applicable cure temperature suitable for the polymerized latex emulsion used. The cure time and temperature are adjusted to prevent thermal decomposition of the resultant coating or substrate. The applicable cure temperature typically varies from 20° C. to 300° C., preferably from 170° C. to 235° C., and the applicable cure time varies from 120 minutes to 1 to 5 seconds, preferably from 30 minutes to 1 minute.

The cure step preferably is conducted simultaneously under an applicable cure pressure suitable for the polymerized latex emulsion being used. The applicable cure pressure varies from 0.1 N/mm² to 3.5 N/mm², preferably from 0.14 N/mm² to 2.0 N/mm². The applicable cure temperature varies from 50° C. to 250° C., preferably from 150° C. to 200° C. The applicable cure time varies from 0.1 second to 5 minutes. Conventional hot pressing means, such as a moulding press having pneumatically or hydraulically pressurized heated platens, are suitable for a batch operation, and conventional hot pressing means, such as a pair of heated calendar rolls, a series of heated calendar rolls, a pair of parallel positioned heated conveyer belts, or UV curing lights, may be used for a continuous operation by squeezing the substrate through them. Calendering at elevated temperature is the preferred process for simultaneous pressing and curing of the press coating.

The thus obtained smooth coating film on the substrate is then used to apply a next coating layer, for example a top coat. In principle, there is no restriction as to the coating composition that can be used as a top coat, as long as there is good adhesion between the top coat and the coating film on top of the substrate. Both pigmented and pigment-free coating compositions can be used for the top coat. In view of the reduction of the amount of solvent released during the drying and curing of the top coat, preference is given to the use of a high solids solvent borne coating, a water borne coating or a hot melt coating. Since the preparation of coated substrates according to the present invention on an industrial scale is preferably done within a relatively short time frame, the curing and drying times of the top coat should be as short as possible. The curing and drying of the top coat can be accelerated by heating the substrate, but in view of its heat-sensitive nature, this is not always possible. Therefore, preference is given to the use of a radiation curable top coat which can be cured within a reasonably short time without the necessity to heat the substrate too much.

Normally, the use of a radiation curable coating composition for the coating of wooden, wood-like and/or cellulose-containing substrates is not advized, since the coating composition will penetrate into the pores, and as the radiation does not reach these areas, the result is uncured coating material. This can give health, safety, and environmental problems, e.g., when the substrate is cut or sanded. These problems occur even years after the lacquer has been applied.

However, in the process according to the present invention, a press coating is applied to the substrate before the radiation curable coating composition is applied. This press coating effectively prevents the penetration of the radiation curable coating composition into the substrate.

Within the framework of the present invention, a radiation curable coating composition is a coating composition which is cured using electromagnetic radiation having a wavelength λ≦500 nm or electron beam radiation. An example of electromagnetic radiation having a wavelength λ≦500 nm is, e.g., UV radiation.

In principle, any radiation curable resin or mixtures of resins can be used in the top coat used in the process according to the present invention. These resins are present in an amount of 20 to 100 wt. % of the composition. Preferably, the resin is present in an amount of 30 to 90 wt. %, more preferred is an amount of 40 to 90 wt. %.

Polyester acrylate resins were found to be very suitable for use in the top coat composition. Examples of suitable commercially available polyester acrylate resins are: Crodamer UVP-215, Crodamer UVP-220 (both ex Croda), Genomer 3302, Genomer 3316 (both ex Rahn), Laromer PE 44F (ex BASF), Ebecryl 800, Ebecryl 810 (both ex UCB), Viaktin 5979, Viaktin VTE 5969, and Viaktin 6164 (100%) (all ex Vianova).

Epoxy acrylate resins can also be used in the top coat composition. Examples of commercially available epoxy acrylate resins are: Crodamer UVE-107 (100%), Crodamer UVE-130 (both ex Croda) Genomer 2254, Genomer 2258, Genomer 2260, Genomer 2263 (all ex Rahn), CN 104 (ex Cray Valley), and Ebecryl 3500 (ex UCB).

Polyether acrylate resins can also be used in the top coat composition. Examples of commercially available polyether acrylate resins are: Genomer 3456 (ex Rahn), Laromer PO33F (ex BASF), Viaktin 5968, Viaktin 5978, and Viaktin VTE 6154 (all ex Vianova).

Urethane acrylate resins can also be used in the top coat composition. Examples of commercially available urethane acrylate resins are: CN 934, CN 976, CN 981 (all ex Cray Valley), Ebecryl 210, Ebecryl 2000, Ebecryl 8800 (all ex UCB), Genomer 4258, Genomer 4652, and Genomer 4675 (all ex Rahn).

Other examples of radiation curable resins that can be used in the top coat composition used in the process according to the present invention are cationic UV curable resins, such as cycloaliphatic epoxide resins (Uvacure 1500, Uvacure 1501, Uvacure 1502, Uvacure 1530, Uvacure 1531, Uvacure 1532, Uvacure 1533, Uvacure 1534, Cyracure UVR-6100, Cyracure UVR-6105, Cyracure UVR-6110, and Cyracure UVR-6128, all ex UCB Chemicals), or SarCat K126 (ex. Sartomer), acrylate modified cycloaliphatic epoxides, caprolactone-based resins (SR 495 (=caprolactone acrylate ex Sartomer), Tone 0201 (=caprolactone triol), Tone 0301, Tone 0305, Tone 0310, (all caprolactone triols ex Union Carbide), aliphatic urethane divinyl ether, aromatic vinyl ether oligomer, bis-maleimide, diglycidyl ether of bisphenol A or neopentyl glycol, hydroxy-functional acrylic monomer, hydroxy-functional epoxide resin, epoxidized linseed-oil, epoxidized polybutadiene, glycidyl ester or partially acrylated bisphenol A epoxy resin.

Further, UV-curable water borne resins can be used in the top coat composition used in the process according to the present invention, such as aliphatic polyurethane dispersions (Lux 101-VP ex Alberdingk Boley), in particular (meth)-acryloyl-functional polyurethane dispersions. Very good results can be obtained when the (meth)acryloyl-functional polyurethane resins comprise alkylene oxide groups.

Other radiation curable compounds that are suitable to be used are, e.g., vinyl ether-containing compounds, unsaturated polyester resins, acrylated polyether-polyol compounds, (meth)acrylated epoxidized oils, (meth)acrylated hyperbranched polyesters, silicon acrylates, maleimide-functional compounds, unsaturated imide resins, compounds suitable for photo-induced cationic curing, or mixtures thereof.

To obtain a suitable application viscosity of the top coat, well-known UV curable monomers can be added as viscosity reducing agents and also reactive oligomers. Examples of these reactive oligomers are tripropylene glycol diacrylate (TPGDA), hexanediol diacrylate (HDDA), and 2-hydroxyethyl methacrylate (HEMA).

Further, the composition can comprise a photoinitiator or a mixture of photo-initiators. Examples of suitable photoinitiators that can be used in the radiation curable composition according to the present invention are benzoin, benzoin ethers, benzilketals, α,α-dialkoxyacetophenones, α-hydroxyalkylphenones, α-aminoalkylphenones, acylphosphine oxides, benzophenone, thioxanthones, 1,2-diketones, and mixtures thereof. It is also possible to use copolymerizable bimolecular photoinitiators or maleimide-functional compounds. Co-initiators such as amine based co-initiators can also be present in the radiation curable coating composition. Daylight cure photoinitiators can likewise be used.

Examples of suitable commercially available photoinitiators are: Esacure KIP 100F and Esacure KIP 150 (both ex Lamberti), Genocure BDK and Velsicure BTF (both ex Rahn), Speedcure EDB, Speedcure ITX, Speedcure BKL, and Speedcure DETX (all ex Lambson),. Cyracure UVI-6990, Cyracure UVI-6974, Cyracure UVI-6976, Cyracure UVI-6992 (all ex Union Carbide), and CGI-901, Darocur 184, Darocur 500, Darocur 1000, and Darocur 1173 (all ex Ciba Chemicals).

However, the presence of a photoinitiator is not necessary. In general, when electron beam radiation is used to cure the composition, it is not necessary to add a photoinitiator. When UV radiation is used, in general a photoinitiator is added.

Although the total amount of photoinitiator in the composition is not critical, it should be sufficient to achieve acceptable curing of the coating when it is irradiated. However, the amount should not be so large that it affects the properties of the cured composition in a negative way. In general, the composition should comprise between 0.1 and 10 wt. % of photoinitiator, calculated on the total weight of the composition when electromagnetic radiation having a wavelength λ≦500 nm is used to cure the coating.

The composition can also contain one or more fillers or additives. The fillers can be any fillers known to those skilled in the art, e.g., barium sulphate, calcium sulphate, calcium carbonate, silicas or silicates (such as talc, feldspar, and china clay).

Additives such as stabilizers, antioxidants, levelling agents, antisettling agents, matting agents, rheology modifiers, surface-active agents, amine synergists, waxes, or adhesion promotors can also be added. In general, the coating composition according to the present invention comprises 0 to 50 wt. % of fillers and/or additives, calculated on the total weight of the coating composition.

The top coat composition used in the process according to the present invention can also contain one or more pigments. Pigments known to those skilled in the art can be used in the radiation curable composition according to the present invention. However, care should be taken that the pigment does not show a too high absorption of the radiation used to cure the composition. In general, the composition according to the present invention comprises 0 to 40 wt. % of pigment, calculated on the total weight of the coating composition.

The top coat can be applied to the substrate by conventional means, such as a curtain coater, spray nozzle, roller coater, or flow coater.

Optionally, one or more other coating layers, so-called intermediate coating layers, are applied on top of the smooth coating film on top of the surface before a top coat is applied. This is done, for example, to get a better adhesion of the top coat or to obtain a top coat with special properties.

In principle, there is no restriction as to the coating composition that can be used for the coating layer(s), as long as there is good adhesion between the coating layer(s) and the coating film on top of the substrate. Both pigmented and pigment-free coating compositions can be used. In view of the reduction of the amount of solvent released during the drying and curing of the coating composition, preference is given to the use of a high solids solvent borne coating composition, a water borne coating composition or a hot melt coating composition. Since the preparation of coated substrates according to the present invention on an industrial scale is preferably done within a relatively short time frame, the curing and drying times of the coating composition should be as short as possible. The curing and drying of the coating composition can be accelerated by heating the substrate, but in view of its heat-sensitive nature, this is not always possible. Therefore, preference is given, to the use of a radiation curable coating composition.

For the additional intermediate coating layer(s) in principle the same types of coating compositions can be used as for the top coat layer, albeit that it is not necessary that the additional intermediate coating layer(s) and the top coat have the same composition.

To obtain a suitable application viscosity of the intermediate layer(s), well-known UV curable monomers can be added as viscosity reducing agents and reactive oligomers. Examples of these reactive oligomers are tripropylene glycol diacrylate (TPGDA), hexanediol diacrylate (HDDA), and 2-hydroxyethyl methacrylate (HEMA). The intermediate coating layer(s) can be applied to the substrate by conventional means, such as by curtain coater, spray nozzle, roller coater, or flow coater.

Optionally, a printing is applied to the substrate before the top coat is applied. This can be done to obtain a substrate with a special surface structure, colouring, or texture.

For the coating of a wooden, wood-like and/or cellulose-containing substrate in an industrial process, preference is given to a process wherein all coating and curing steps are performed on a single production line. In such a process the substrate is placed on a belt which moves at a continuous speed. The substrate is then successively coated with the press coat, heated and pressed to dry and cure the press coat, optionally coated with additional coating layer(s), heated or treated in another way to cure the optionally present layer(s), optionally provided with a printing, coated with a top coat, and heated or treated in another way to cure the top coat.

The process according to the present invention wherein a wooden, wood-like and/or cellulose containing substrate is coated by first applying a press coat and then applying other coating layer(s) presents the following advantages over a process wherein such a press coat is not used:

Reduction of the total amount of paint needed to obtain a substrate with the same properties and appearance;

Reduction of the total amount of solvent needed to obtain a substrate with the same properties and appearance;

Reduction of the total amount of energy needed to obtain a substrate with the same properties and appearance;

In particular for substrates that are coated with a UV-curable top coat or an intermediate coating, a reduction of the amount of unreacted monomers. These monomers can give health, safety, and environmental problems, e.g., when the substrate is cut or sanded. These problems occur even years after the lacquer has been applied.

Improvement of the heat resistance of the substrate.

The invention further relates to a wooden, wood-like and/or cellulose-containing substrate coated with a press coat and at least one radiation curable coating layer with an amount of unreacted double bonds in the substrate after curing of the radiation curable coating layer, as measured by IR Chromatography, of less than 15%, preferably less than 10%, of the total amount of double bonds present in the uncured coating composition. This low amount of unreacted double bonds is probably due to the effective sealing of the porous surface of the substrate by using the press coat. Due to this sealing, the penetration of the radiation curable coating layer into the substrate is reduced.

The term IR Chromatography within the context of this application should be taken to mean Chromatography followed by Infrared spectroscopy, for instance Gas Chromatography followed by Infrared spectroscopy. If Liquid Chromatography is used, care should be taken that the IR spectrum of the mobile phase does not interfere with the IR spectrum of the sample.

The amount of extractables can be measured by removal of a 5 cm²×1-2 mm sample from the surface of the substrate, extraction of the sample with dichloro-methane, and analysis of the dichloromethane containing the extractables by GC/FID (Gas Chromatography/Flame Ionization Detection) in combination with GC/MS (Gas Chromatography/Mass Spectroscopy).

The invention will be elucidated with reference to the following examples. These are intended to illustrate the invention but are not to be construed as limiting in any manner the scope thereof.

### EXAMPLES

### Example 1 A

A Medium Density Fibre board (MDF) substrate was placed on a belt moving at a speed of 15 m/min and a white pigmented press coat emulsion comprising (pbw denotes parts by weight):

26.7 pbw of water;

20.7 pbw of an acrylic polymer having a T_{g} of 34° C.;

16.8 pbw of pigment;

31.5 pbw of a mixture of fillers; and

4.3 pbw of a mixture of additives

was applied to the MDF substrate at 15-20 g/m². The press coat was allowed to dry by passing the MDF substrate through an oven and the press coat was pressed and cured by passing through a pair of calendering rolls at a temperature between 150° C. and 200° C. and a pressure of about 1 N/mm².

On top of the thus formed coating film a white pigmented solvent borne top coat (Proff 355 NCS S-0502 Y available from Akzo Nobel Wood Coatings AB Sweden diluted at 50 wt. % solids content) was applied with a curtain coater at 100 g/m². The top coat was allowed to cure by passing the substrate through a second oven. The whole process was performed on a single production line without removing the substrate from the belt.

### Example 1 B (Comparative)

By way of comparison, using the same conditions a coated MDF substrate was prepared not using a press coat. In a first step a solvent borne sealer coating (Proff Surf 150 available from Akzo Nobel Wood Coatings AB Sweden) was applied, in the second step a white pigmented solvent borne top coat of Example 1 A was applied at 100 g/m². To obtain a substrate with the same properties and appearance as in Example 1 A, the sealer coating had to be applied at 100 g/m². In comparison to Example 1 A, in this comparative example 100% more solvent had to be used to obtain a coated MDF substrate with the same properties and appearance. Further, in the comparative example the energy consumption of the whole process was higher in view of the larger volume of solvent that had to be evaporated.

### Example 2 A

A Medium Density Fibre board (MDF) substrate was placed on a belt moving at a speed of 15 m/min and the white pigmented press coat of Example 1 A was applied to the MDF substrate at 15-20 g/m². The press coat was allowed to dry by passing the MDF substrate through an oven and the press coat was pressed and cured by passing through a pair of calendering rolls at a temperature between 150° C. and 200° C. and a pressure of about 1 N/mm².

On top of the thus formed coating film a white pigmented top coat (IC 102 Ikeawhite 5 available from Akzo Nobel Wood Coatings AB Sweden diluted to a solids content of 35 wt. %) was applied with a curtain coater at 100 g/m². The top coat was allowed to cure by passing the substrate through a second oven.

The whole process was performed on a single production line without removing the substrate from the belt.

### Example 2 B (Comparative)

By way of comparison, using the same conditions a coated MDF substrate was prepared not using a press coat. In a first step a solvent borne sealer coating (Proff Surf 150 available from Akzo Nobel Wood Coatings AB Sweden) was applied, in the second step the white pigmented top coat of Example 2 A was applied at 100 g/m². To obtain a substrate with the same properties and appearance as in Example 2 A, the sealer coating had to be applied at 100 g/m².

In comparison to Example 2 A, in this comparative example 100% more solvent had to be used to obtain a coated MDF substrate with the same properties and appearance. Further, in the comparative example the energy consumption of the whole process was higher in view of the larger volume of solvent that had to be evaporated.

### Example 3 A

A Medium Density Fibre board (MDF) substrate was placed on a belt moving at a speed of 15 m/min and the white pigmented press coat of Example 1 A was applied to the MDF substrate at 15-20 g/m². The press coat was allowed to dry by passing the MDF substrate through an oven and the press coat was pressed and cured by passing through a pair of calendering rolls at a temperature between 150° C. and 200° C. and a pressure of about 1 N/mm².

On top of the thus formed coating film a white pigmented water borne top coat (Aqua Täck Line available from Akzo Nobel Wood Coatings AB Sweden) was applied with a curtain coater at 100 g/m². The top coat was allowed to cure by passing the substrate through a second oven.

The whole process was performed on a single production line without removing the substrate from the belt.

### Example 3 B (Comparative)

By way of comparison, using the same conditions a coated MDF substrate was prepared not using a press coat. In a first step a water borne primer coating, Aqua Täck Line available from Akzo Nobel Wood Coatings AB Sweden, was applied, in the second step the same white pigmented water borne coating was applied as a top coat at 100 g/m². To obtain a substrate with the same properties and appearance as in Example 3 A, the primer coating had to be applied at 100 g/m².

In comparison to Example 3 A, in this comparative example the energy consumption of the whole process was higher in view of the larger volume of water that had to be evaporated.

### Example 4 A

A Medium Density Fibre board (MDF) substrate was placed on a belt moving at a speed of 15 m/min and the white pigmented press coat of Example 1 A was applied to the MDF substrate at 15-20 g/m². The press coat was allowed to dry by passing the MDF substrate through an oven and the press coat was pressed and cured by passing through a pair of calendering rolls at a temperature between 150° C. and 200° C. and a pressure of about 1 N/mm².

On top of the thus formed coating film the following coating layers were applied:

a UV sealer (IS 401 UV Sealer available from Akzo Nobel Wood Coatings AB Sweden) was applied with a roller coater at 8 g/m²;

a white pigmented UV base coat (UV Basecoat Br. Hvid available from Akzo Nobel Wood Coatings AB Sweden) was applied with a roller coater at 8 g/m²;

a white pigmented UV base coat (UV Basecoat Br. Hvid available from Akzo Nobel Wood Coatings AB Sweden) was applied with a roller coater at 8 g/m²;

a white pigmented top coat (UV top coat Ikea No. 5 available from Akzo Nobel Wood Coatings AB Sweden) was applied with an Optiroller at 23 g/m²;

After application, each coating layer was dried and cured before application of the next layer. The coating layers were allowed to cure by passing the substrate under a UV lamp. Before applying the first layer of the base coat the substrate was sanded.

The whole process was performed on a single production line without removing the substrate from the belt.

### Example 4 B (Comparative)

By way of comparison, using the same conditions a coated MDF substrate was prepared not using a press coat. In a first step a UV putty (IF 401 UV light filler available from Akzo Nobel Wood Coatings AB Sweden) was applied at 20 g/m² and cured.

On top of the cured putty the following coating layers were applied:

a UV sealer (IS 401 UV Sealer available from Akzo Nobel Wood Coatings AB Sweden) was applied with a roller coater at 8 g/m²;

a white pigmented UV base coat (UV Basecoat Br Hvid available from Akzo Nobel Wood Coatings AB Sweden) was applied with a roller coater at 8 g/m²;

a white pigmented UV base coat (UV Basecoat Br. Hvid available from Akzo Nobel Wood Coatings AB Sweden) was applied with a roller coater at 8 g/m²;

a white pigmented UV base coat (UV Basecoat Br. Hvid available from Akzo Nobel Wood Coatings AB Sweden) was applied with a roller coater at 8 g/m²;

a white pigmented top coat (UV top coat Ikea No. 5 available from Akzo Nobel Wood Coatings AB Sweden) was applied with an Optiroller at 23 g/m²;

After application, each coating layer was dried and cured before application of the next layer. The coating layers were allowed to cure by passing the substrate under a UV lamp.

The whole process was performed on a single production line without removing the substrate from the belt.

In comparison to Example 4 A, in this comparative example more paint had to be used to obtain a substrate with the same properties and appearance resulting in a higher overall cost price. Further, in the coated substrate of Example 4 B approximately 20% of the double bonds in the coating composition were not converted, while in the coated substrate of Example 4 A only 3% of the double bonds in the coating composition were not converted. The conversion of double bonds was measured by IR Chromatography.

The amount of unconverted double bonds in the coated substrate indicates that the material contains uncured monomeric material.

### Example 5 A

A Medium Density Fibre board (MDF) substrate was placed on a belt moving at a speed of 15 m/min and the white pigmented press coat of Example 1 A was applied to the MDF substrate at 15-20 g/m². The press coat was allowed to dry by passing the MDF substrate through an oven and the press coat was pressed and cured by passing through a pair of calendering rolls at a temperature between 150° C. and 200° C. and a Pressure of about 1 N/mm².

On top of the thus formed coating film a white pigmented water borne primer (IP 610 Aqua Primer 2 available from Akzo Nobel Wood Coatings AB Sweden) was applied with a roller coater at 25 g/m². After drying and curing of the primer, a UV curable top coat (UV top coat Ikea No. 5 available from Akzo Nobel Wood Coatings AB Sweden) was applied with an Optiroller at 5 g/m². The top coat was allowed to cure by passing the substrate under a UV lamp.

The whole process was performed on a single production line without removing the substrate from the belt.

### Example 5 B (Comparative)

By way of comparison, using the same conditions a coated MDF substrate was prepared not using a press coat. In a first step a water borne primer coating (IP 610 Aqua Primer 2 available from Akzo Nobel Wood Coatings AB Sweden) was applied, in the second step a white pigmented UV curable top coat (UV top coat Ikea No. 5 available from Akzo Nobel Wood Coatings AB Sweden) was applied at 5 g/m². To obtain a substrate with the same properties and appearance as in Example 5 A, the primer coating had to be applied in 3 passes at 35 g/m².

In comparison to Example 5 A, in this comparative example the energy consumption of the whole process was higher in view of the larger volume of water that had to be evaporated. Further, the paint consumption in the comparative process was higher

### Example 6 A

A Medium Density Fibre board (MDF) substrate was placed on a belt moving at a speed of 15 m/min and the white pigmented press coat of Example 1 A was applied to the MDF substrate at 15-20 g/m². The press coat was allowed to dry by passing the MDF substrate through an oven and the press coat was pressed and cured by passing through a pair of calendering rolls at a temperature between 150° C. and 200° C. and a pressure of about 1 N/mm².

On top of the thus formed coating film a UV curable putty (IF 401 UV light filter available from Akzo Nobel Wood Coatings AB Sweden) was applied at 5-15 g/m². The putty was allowed to cure by passing the substrate under a UV lamp. On top of the cured putty a UV curable sealer coating (IS 483 W-W UV Sealer available from Akzo Nobel Wood Coatings AB Sweden) was applied at 6-8 g/m². The sealer was allowed to cure by passing the substrate under a UV lamp. On top of the cured sealer coating a UV curable top coat (UV top coat Ikea no. 5 available from Akzo Nobel Wood Coatings AB Sweden) was applied at 5 g/m². The top coat was allowed to cure by passing the substrate under a UV lamp.

The whole process was performed on a single production line without removing the substrate from the belt.

### Example 6 B (Comparative)

By way of comparison, using the same conditions a coated MDF substrate was prepared not using a press coat. To obtain a substrate with the same properties and appearance as in Example 6 A, the UV curable putty of Example 6 A had to be applied at 15-40 g/m².

In comparison to Example 6 A, in this comparative example more paint had to be used to obtain a substrate with the same properties and appearance, resulting in a higher overall cost price. Further, in the coated substrate of Example 6 B approximately 25% of the double bonds in the coating composition were not converted, while in the coated substrate of Example 6 A only 7% of the double bonds in the coating composition were not converted. The conversion of double bonds was measured by IR Chromatography. The amount of unconverted double bonds in the coated substrate indicates that the material contains uncured monomeric material.

We claim:

1. A process for the coating of a wooden, wood-like and/or cellulose-containing substrate comprising the steps of:
a) applying a press coating to the substrate;
b) applying heat and pressure to the coated substrate to cure the press coating and to obtain a substrate with a smooth coating film, with the pressure being such that the substrate is not substantially compressed;
c) applying a top coat to the substrate after the curing of the press coating; and
d) curing said top coat.

2. The process according to claim 1, wherein in an additional step before the top coat is applied, a primer coating is applied and cured.

3. The process according to claim 1, wherein all process steps are performed on a single production line.

4. The process according to claim 1, wherein the top coat is a radiation curable top coat and the radiation curable top coat is cured using UV radiation.

5. The process according to claim 1, wherein before the top coat is applied, a printing is applied on the substrate and the top coat is applied on top of said printing.

6. The process according to claim 1, wherein the press coat is a aqueous colloidal dispersion comprising particles of a polymer of an ethylenically unsaturated monomer and 40-60 wt. %, based on the total weight, of the emulsion solids of filler and/or pigment.

7. A wooden, wood-like and/or cellulose-containing substrate coated with a press coat and at least one radiation curable coating layer comprising unreacted double bonds wherein the amount of unreacted double bonds in the substrate after curing of the radiation curable coating layer as measured by IR Chromatography is less than 15% of the total amount of double bonds present in the uncured coating composition.

8. The substrate according to claim 7, wherein the amount of unreacted double bonds in the substrate as measured by IR Chromatography is less than 10% of the total amount of double bonds present in the uncured coating composition.
